(19) United States
(12) Patent Application Publication
(10) Pub. No.: US 2022/0079343 A1
(43) Pub. Date: Mar. 17, 2022

(54) HOOK FOR WRITING BOARD

(71) Applicant: TAICANG BOARDSTAR OFFICE SUPPLIES CO., LTD., Suzhou City, Jiangsu (CN)

(72) Inventor: Hongbiao KAN, Suzhou City, Jiangsu (CN)

(21) Appl. No.: 16/973,328

(22) PCT Filed: Apr. 16, 2020
(86) PCT No.: PCT/CN2020/084999

§ 371 Date: Dec. 8, 2020

(30) Foreign Application Priority Data
Mar. 25, 2020 (CN) 202020399201.4

(51) Int. Cl. A47B 97/06

(52) U.S. Cl. CPC A47B 97/06; B43L 1/00

(57) ABSTRACT

The utility model discloses a hook for a writing board. The hook is detachably fixed on a frame of the writing board. The hook includes a base; a bottom end of the base is protruded to form a clamping block; the clamping block is detachably arranged in the frame of the writing board; a top end of the base is at least protruded to form a suspension arm; and the suspension arm is concavely provided with at least one suspension hole. According to the utility model, the structure is simple, and the hook may be randomly disassembled and assembled in the frame of the writing board, thus facilitating suspension of the writing board, preventing the writing board from falling and providing one more method for the fixation of the writing board.

### TECHNICAL FIELD

The utility model relates to the technical field of office appliances, and in particular, to a hook for a writing board.

### BACKGROUND

The writing board may facilitate work and has low requirements on the working environment; and during use, the writing board needs to be fixed or suspended. In the prior art, to realize a suspension function, a plurality of metal circular rings or metal triangular rings mounted on the frame of the writing board cannot be separated from the frame and cannot be taken down and placed on other frames, and external screws and the like need to be mounted in cooperation with the writing board; in addition, for the large-size writing board, the existing structure cannot add a metal circular ring or metal triangular ring to improve the stability and safety of fixation according to the actual installation situation. Therefore, it is necessary to propose improvements.

### SUMMARY

An objective of the present utility model is to provide a hook for a writing board to solve the problems in the background art.

To achieve the foregoing objective, the present utility model adopts the following technical solutions:

according to a hook for a writing board, the writing board is suspended by the hook; the writing board comprises a writing board and a frame wrapping a periphery of the writing board; the frame is concavely provided with a sliding groove; the hook is detachably fixed on the frame of the writing board; the hook comprises a base; a bottom end of the base is protruded to form a clamping block; the clamping block is detachably fixed in the frame of the writing board; a top end of the base is at least protruded to from a suspension arm; and the suspension arm is concavely provided with at least one suspension hole.

Preferably, the clamping block is connected to the bottom of the base through a cylinder, and a diameter of the cylinder is not greater than an opening width of the sliding groove.

Preferably, in the hook for the writing board, the clamping block is of a cuboid structure; a width of the clamping block is as same as the diameter of the cylinder; a length of the clamping block is set corresponding to a width of the sliding groove; and a thickness of the clamping block is set corresponding to a depth of the sliding groove.

Preferably, in the hook for the writing board, an end face of the clamping block in a length direction is of a slope structure.

Preferably, in the hook for the writing board, the suspension arm is perpendicular to the base; the suspension arm is perpendicular to a length direction of the clamping block; and the suspension arm and the base are connected in a smooth transition manner.

Preferably, in the hook for the writing board, an inner side surface of a top end of the suspension arm is protruded to form a strengthening portion.

Preferably, in the hook for the writing board, an end face of a side, departing from the clamping block, of the base is protruded to form a rotary knob.

Compared with the prior art, the present utility model has the following beneficial effects:

according to the utility model, the structure is simple, and the hook may be randomly disassembled and assembled in the frame (a long side or a short side) of the writing board; meanwhile, a position of the hook may be randomly adjusted according to a position of an external screw, which is flexible and changeable, thereby improving the stability and safety of fixation and providing better writing experience.

### BRIEF DESCRIPTION OF THE DRAWINGS

FIG. 1 is a usage schematic diagram of a hook for a writing board according to a specific embodiment I of the present utility model.

FIG. 2 is a structural schematic diagram of a hook for a writing board according to a specific embodiment I of the present utility model.

FIG. 3 is a side view of a hook for a writing board according to a specific embodiment I of the present utility model.

FIG. 4 is a structural schematic diagram of a hook for a writing board according to a specific embodiment II of the present utility model.

FIG. 5 is a structural schematic diagram of a hook for a writing board according to a specific embodiment III of the present utility model.

FIG. 6 is a side view of a hook for a writing board according to a specific embodiment III of the present utility model.

### DESCRIPTION OF EMBODIMENTS

The technical schemes of the embodiments of the present utility model are clearly and completely described below with reference to the accompanying drawings in the embodiments of the present utility model, and it is apparent that the described embodiments are only a part of embodiments of the present utility model, instead of all the embodiments.

### Embodiment I

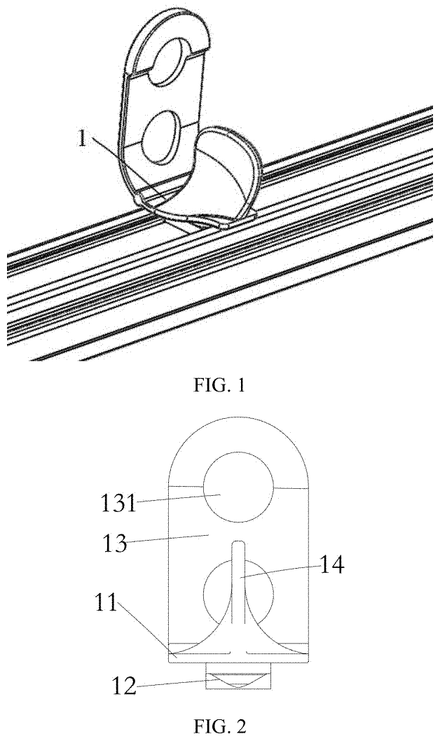

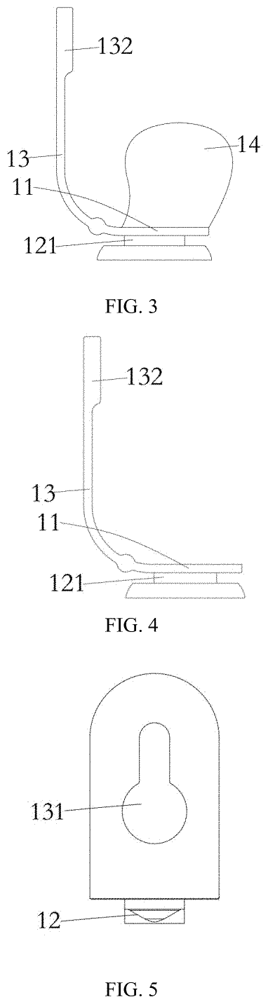

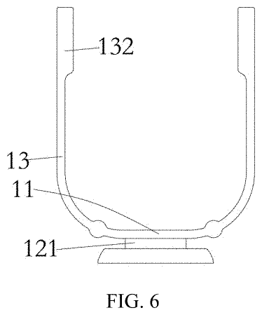

Referring to FIG. 1 to FIG. 3, in a hook for a writing board, the writing board is suspended on a screw and the like of the wall by the hook 1; generally, the writing board includes a writing board, a frame wrapping a periphery of the writing board as well as a wrap angle connected to an adjacent frame (a mounting hole may be reserved in the wrap angle); the frame may be an aluminum profile or plastic and is concavely provided with a sliding groove; and the invention point of the present application is: the hook 1 is detachably fixed on the frame of the writing board, the hook includes a base 11, a bottom end of the base 11 is protruded to form a clamping block 12, the clamping block 12 is detachably fixed in the frame of the writing board, a top end of the base 11 is protruded to form a suspension arm 13, and the suspension arm 13 is concavely provided with two suspension holes 131.

In the technical solution, the hook may be entirely disassembled and assembled on the frame (both a long side and a short side are acceptable) of the writing board according to the utility model, the writing board is suspended on a screw and the like of the wall by the suspension hole (shape and) in the suspension arm; the hook can be directly disassembled when not required, so that the overall appearance is beautified; according to the utility model, the structure is simple, and the hook may be randomly disassembled and assembled in the frame (a long side or a short side) of the writing board; meanwhile, a position of the hook may be randomly adjusted according to a position of an external screw, which is flexible and changeable, thereby improving the stability and safety of fixation and providing better writing experience.

Further, the clamping block 12 is connected to the bottom of the base 11 through a cylinder 121, and a diameter of the cylinder 121 is not greater than opening width of the sliding groove.

Further, the clamping block 12 is of a cuboid structure; a width of the clamping block is as same as the diameter of the cylinder 121; a length of the clamping block 12 is set corresponding to a width of the sliding groove; and a thickness of the clamping block 12 is set corresponding to a depth of the sliding groove.

In the above two technical solutions, the clamping block is slidably arranged in the sliding groove, the clamping block freely slides in the sliding groove in a width direction and is randomly mounted in the frame (a long side or short side) of the writing board, a position is randomly adjusted, and the hook is rotated by 90° when the clamping block arrives at a position needing to be fixed, thereby realizing safe locking and avoiding a rotary falling phenomenon after suspension.

Further, an end face of the clamping block 12 in a length direction is of a slope structure.

In the technical solution, the slope is of an arc-shaped or oblique plane structure, so that the clamping block can be clamped into the sliding groove successfully when rotating.

Further, the suspension arm 13 is perpendicular to the base 11, the suspension arm 13 is perpendicular to the length direction of the clamping block, and the suspension arm 13 and the base 11 are connected in a smooth transition manner.

In the technical solution, after the suspension arm is suspended on the wall, the writing board is in a vertical state, and a strength of a connection position of the suspension arm and the base may be enhanced by increasing a thickness.

Further, an inner side surface of a top end of the suspension arm 13 is protruded to form a strengthening portion 132.

In the technical solution, an overall strength of a stressed part is enhanced by the strengthening portion, thereby improving the use safety and prolonging the service life.

Further, an end face of a side, departing from the clamping block, of the base is protruded to form a rotary knob 14.

In the technical solution, a shape of the rotary knob is not defined as long as it is convenient to rotate the hook by hand.

### Embodiment II

Compared with the embodiment I, a rotary knob is not provided in the embodiment, and the hook is rotated by pulling the suspension arm.

### Embodiment III

Compared with the embodiment I, a rotary knob is not provided in the embodiment; meanwhile, two parallel suspension arms are arranged and are concavely provided with suspension holes with small upper parts and big lower parts.

In conclusion, according to the utility model, the structure is simple, and the hook may be randomly disassembled and assembled in the frame of the writing board; meanwhile, a position of the hook may be randomly adjusted according to a position of an external screw, which is flexible and changeable, thereby improving the stability and safety of fixation and providing better writing experience.

It should be noted that the relationship terms, such as “first” and “second”, are used herein only for distinguishing one entity or operation from another entity or operation but do not necessarily require or imply that there exists any actual relationship or sequence of this sort between these entities or operations. Furthermore, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device. In the case of no more limitations, the element limited by the sentence “comprising a . . . ” does not exclude that there exists another same element in the process, method, merchandise or device comprising the element.

The above descriptions are merely specific implementation manners of the present application. It should be noted that those skilled in the art may make some improvements and modifications without departing from the principle of the present application. These improvements and modifications should also be regarded as the scope of protection of this application.

What is claimed is:

1. A hook for a writing board, wherein the writing board is suspended by the hook; the writing board comprises a writing board and a frame wrapping a periphery of the writing board; the frame is concavely provided with a sliding groove; the hook is detachably fixed on the frame of the writing board; the hook comprises a base; a bottom end of the base is protruded to form a clamping block; the clamping block is detachably fixed in the frame of the writing board; a top end of the base is at least protruded to from a suspension arm; and the suspension arm is concavely provided with at least one suspension hole.

2. The hook for a writing board according to claim 1, wherein the clamping block is connected to the bottom of the base through a cylinder, and a diameter of the cylinder is not greater than an opening width of the sliding groove.

3. The hook for a writing board according to claim 2, wherein the clamping block is of a cuboid structure; a width of the clamping block is as same as the diameter of the cylinder; a length of the clamping block is set corresponding to a width of the sliding groove; and a thickness of the clamping block is set corresponding to a depth of the sliding groove.

4. The hook for a writing board according to claim 3, wherein an end face of the clamping block in a length direction is of a slope structure.

5. The hook for a writing board according to claim 1, wherein the suspension arm is perpendicular to the base; the suspension arm is perpendicular to a length direction of the clamping block; and the suspension arm and the base are connected in a smooth transition manner.

6. The hook for a writing board according to claim 5, wherein an inner side surface of a top end of the suspension arm is protruded to form a strengthening portion.

7. The hook for a writing board according to claim 1, wherein an end face of a side, departing from the clamping block, of the base is protruded to form a rotary knob.
